(19) United States
(12) Patent Application Publication
(10) Pub. No.: US 2025/0002248 A1
(43) Pub. Date: Jan. 2, 2025

(54) SLIDING DEVICE AND TRASH CAN

(71) Applicant: Jiangmen Jinlong High Technology Industrial Co., LTD., Guangdong (CN)

(72) Inventors: Jinsheng LIAO, Guangdong (CN); Zhaofa TANG, Guangdong (CN)

(21) Appl. No.: 18/735,720

(22) Filed: Jun. 6, 2024

(30) Foreign Application Priority Data
Jun. 28, 2023 (CN) 2023216780309

(51) Int. Cl. B65F 1/16

(52) U.S. Cl. CPC B65F 1/1638

(57) ABSTRACT

A sliding device and a trash can are disclosed. The sliding device includes: a motor with an output shaft; a sliding member disposed on the output shaft, where the sliding member forms a plurality of connecting portions protruding in an axial direction of the output shaft, and each of the connecting portions is formed with a convex portion protruding in a radial direction of the output shaft; a transmission member, arranged around the sliding member, where the transmission member is provided with a plurality of recesses, each of the recesses matches with the respective convex portion, a sliding surface is disposed between each adjacent pair of the recesses, and the recess is clamped with the respective convex portion to fix the transmission member and the sliding member, and the transmission member and the sliding member are rotatable relative to each other.

### CROSS-REFERENCE TO RELATED APPLICATION

This application is based on and claims the benefit of priority from Chinese Patent Application No. 202321678030.9, filed on 28 Jun. 2023, the entirety of which is incorporated by reference herein.

### TECHNICAL FIELD

The present disclosure relates to the technical field of trash cans, and in particular to a sliding device and a trash can.

### BACKGROUND

Most of the flip-top trash cans on the market are operated by stepping on a pedal and using a lever mechanism for transmission to flip the lid, which is laborious. After long-term use, the pedal and transmission structural members are prone to looseness and damage. Consequently, motors have been used to replace manual pedaling to drive the lip to open and close, making operation more convenient. But when there is an external force to flip the lip, the external force exerted on the lip will be directly transmitted to the motor, potentially causing overload, gear stripping, and motor damage, thus affecting its lifespan.

### SUMMARY

The present disclosure aims to solve at least one of the technical problems in the existing technology. To this end, the present disclosure proposes a sliding device and a trash can, which can prevent the motor from being damaged by an external force exerted on the lip, protect the motor, and extend the lifespan of the motor.

The sliding device according to the embodiment in a first aspect of the present disclosure includes: a motor, provided with an output shaft; a sliding member, disposed on the output shaft, where the sliding member forms a plurality of connecting portions protruding in an axial direction of the output shaft, the plurality of connecting portions are arranged at intervals in a circumferential direction of the output shaft, and each of the connecting portions is formed with a convex portion protruding in a radial direction of the output shaft; a transmission member, arranged around the sliding member, where the transmission member is provided with a plurality of recesses, each of the recesses matches with the respective convex portion, a sliding surface is disposed between each adjacent pair of the recesses, and each of the recesses is lamped with the respective convex portion to fix the transmission member and the sliding member, and the transmission member and the sliding member are rotatable relative to each other.

The sliding device according to the embodiment in the first of the present disclosure has at least the following beneficial effects. The elastic force of the connecting portions drives the convex portions and the recesses to be clamped. When the external force transmitted to the output shaft exceeds the set value to make the connecting portions deform, the convex portions slide out of the respective recesses and slide along the sliding surfaces to realize the slippage between the output shaft and the transmission member until the external force transmitted to the output shaft is lower than the set value, at which point the convex portions and the recesses will be clamped again, thereby protecting the motor from overload or damage caused by external forces and extending the lifespan of the motor.

According to some embodiments of the present disclosure, the convex portion is provided with an arc surface matching with an inner wall of the respective recess.

According to some embodiments of the present disclosure, the sliding member is provided with an insertion hole, an inner wall of the insertion hole protrudes to form a positioning portion, the output shaft is provided with a flat surface, and the flat surface abuts against the positioning portion.

The trash can according to the embodiment in the second aspect of the present disclosure includes a mounting ring, a lip and the sliding device described in the embodiment in the first aspect of the present disclosure. The lip is hinged to the mounting ring, and the transmission member is configured to drive the lip to rotate.

The trash can according to an embodiment of a second aspect in the present disclosure has at least the following beneficial effects. The elastic force of the connecting portions drives the convex portions and the recesses to be clamped. When the external force transmitted to the output shaft exceeds the set value to make the connecting portions deform, the convex portions slide out of the respective recesses and slide along the sliding surfaces to realize the slippage between the output shaft and the transmission member until the external force transmitted to the output shaft is lower than the set value, at which point the convex portions and the recesses will be clamped again, thereby protecting the motor from overload or damage caused by external forces and extending the lifespan of the motor.

According to some embodiments of the present disclosure, the lip is provided with a transmission shaft, one end of the transmission shaft is provided with a first tooth portion, the transmission member is provided with a second tooth portion, and the first tooth portion and the second tooth portion are engaged with each other.

According to some embodiments of the present disclosure, the mounting ring is provided with a mounting seat, the transmission shaft is hinged with the mounting seat, the other end of the transmission shaft is provided with a limiting block, and the limiting block is capable of being abutting against the mounting seat.

According to some embodiments of the present disclosure, the transmission member is provided with a first connecting rod, the lip is provided with a first connecting block, the first connecting block is hinged with the mounting ring, a second connecting rod is disposed between the first connecting rod and the first connecting rod, one end of the second connecting rod is hinged with the first connecting rod, and the other end of the second connecting rod is hinged with the first connecting block.

According to some embodiments of the present disclosure, the second connecting rod protrudes to form a limiting portion, and the limiting portion is capable of being abutting against the transmission member or the first connecting block.

According to some embodiments of the present disclosure, the lip is provided with a second connecting block, the second connecting block is hinged with the mounting ring, and the second connecting block is connected to the transmission member.

According to some embodiments of the present disclosure, the second connecting block and the transmission member are integrally formed.

Additional aspects and advantages of the present disclosure will be set forth in part in the description which follows, and will be partially apparent from the description, or understood by practice of the present disclosure.

### BRIEF DESCRIPTION OF DRAWINGS

The above and/or additional aspects and advantages of the present disclosure will become apparent and readily understood from the description of the embodiments in conjunction with the following drawings. In the drawings,

FIG. 1 is a schematic diagram of a trash can according to an embodiment in a second aspect of the present disclosure;

FIG. 2 is a schematic diagram of a first implementation of a sliding device according to an embodiment in a first aspect of the present disclosure;

FIG. 3 is a schematic diagram of a sliding member in the sliding device according to an embodiment in a first aspect of the present disclosure;

FIG. 4 is a schematic diagram of a transmission member in the sliding device according to an embodiment in a first aspect of the present disclosure;

FIG. 5 is a schematic diagram of a second implementation of a sliding device according to an embodiment in a first aspect of the present disclosure; and

FIG. 6 is a schematic diagram of a third implementation of a sliding device according to an embodiment in a first aspect of the present disclosure.

### EXPLANATION OF REFERENCE SIGNS

lip 110, transmission shaft 111, first tooth portion 112, limiting block 113, first connecting block 114, second connecting block 115, mounting ring 120, mounting seat 121;
motor 210, output shaft 211, flat surface 212, sliding member 220, connecting portion 221, convex portion 222, positioning portion 223, insertion hole 224, transmission member 230, recess 231, second tooth portion 232, sliding surface 233, first connecting rod 234;
second connecting rod 310, limiting portion 311.

### DETAILED DESCRIPTION

The embodiments of the present disclosure are described in detail below, examples of which are shown in the accompanying drawings, the same or similar reference signs throughout represent the same or similar elements or elements with the same or similar functions. The embodiments described below with reference to the drawings are exemplary, only used to explain the present disclosure and cannot be understood as a limitation to the present disclosure.

In the description of the present disclosure, it should be understood that the orientation descriptions involved, such as the orientation or positional relationships indicated by up, down, front, back, left, right, etc. are based on the orientation or positional relationships shown in the drawings, and are only intended to facilitate the description of the present disclosure and simplify the description rather than indicating or implying that the device or element referred to must have a specific orientation, be constructed and operated in a specific orientation, and therefore cannot be understood as a limitation to the present disclosure.

In the description of the present disclosure, several means one or more, “a plurality of” means two or more; greater than, less than, more than, etc. are understood as excluding the following number, while above, below, within, etc. are understood as including the following number. If there is a description of first and second, it is only for the purpose of distinguishing technical features, and cannot be understood as indicating or implying the relative importance or implicitly indicating the number of indicated technical features or implicitly indicating the order of indicated technical features.

In the description of the present disclosure, unless otherwise explicitly limited, words such as setting, installation, and connection should be understood in a broad sense. Those of ordinary skills in the art can reasonably determine the specific meaning of the above words in the present disclosure in combination with the specific content of the technical solution.

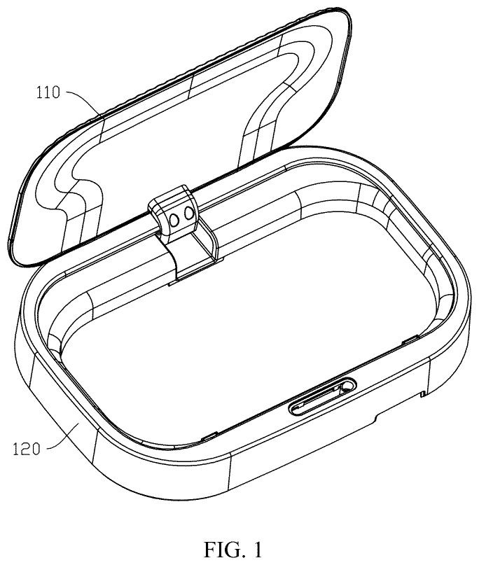

Referring to FIGS. 1 to 4, a sliding device according to an embodiment in a first aspect of the present disclosure includes: a motor 210, provided with an output shaft 211; a sliding member 220, disposed on the output shaft 211, where the sliding member 220 forms a plurality of connecting portions 221 protruding in an axial direction of the output shaft 211, the plurality of connecting portions 221 are arranged at intervals in a circumferential direction of the output shaft 211, each of the connecting portions 221 forms a convex portion 222 protruding in a radial direction of the output shaft 211; a transmission member 230, arranged around the sliding member 220, where the transmission member 230 is provided with a plurality of recesses 231, each of the recesses 231 matches with a respective one of the convex portions 222, a sliding surface 233 is disposed between two adjacent recesses 231, each of the recesses 231 is lamped with a respective one of the convex portions 222 to fix the transmission member and the sliding member 220, and the transmission member and the sliding member 220 can rotate relative to each other.

The elastic force of the connecting portions 221 drives the convex portions 222 to clamp with the respective recesses 231, so that the output shaft 211 of the motor 210 can cooperate with the transmission member 230 by the sliding member 220 to drive the lip 110 to rotate. When the lip 110 is subjected to an external force, the external force transmitted to the output shaft 211 exceeds the set value to make the connecting portions 221 deform, the output shaft 211 rotates, so that the convex portions 222 slide out of the respective recesses 231 and slide along the sliding surfaces 233 to realize the slippage between the output shaft 211 and the transmission member 230 until the external force transmitted to the output shaft 211 is lower than the set value, at which point the convex portions 222 and the recesses 231 are clamped again, thereby protecting the motor 210 from overload or damage caused by external forces and extending the lifespan of the motor 210.

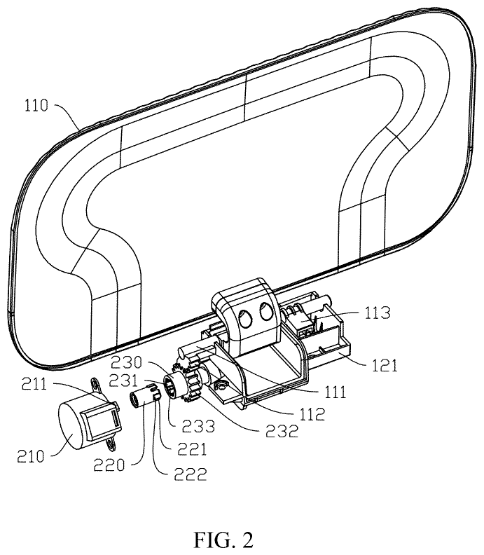

It can be understood that, referring to FIG. 2, each of the convex portions is provided with an arc surface matching with an inner wall of the respective recess 231, reducing the resistance when the convex portion 222 slides out of the recess 231, making it easier for the convex portion 222 to slide out of the recess 231, which prevents the sliding member 220 from being invalid.

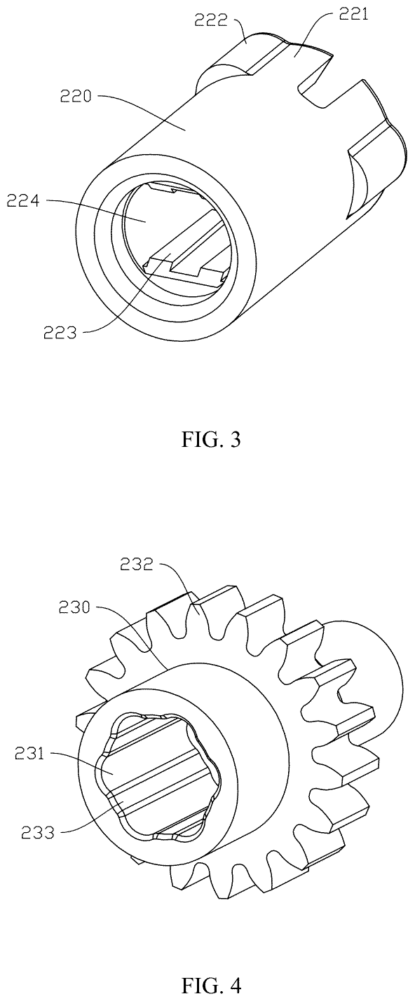

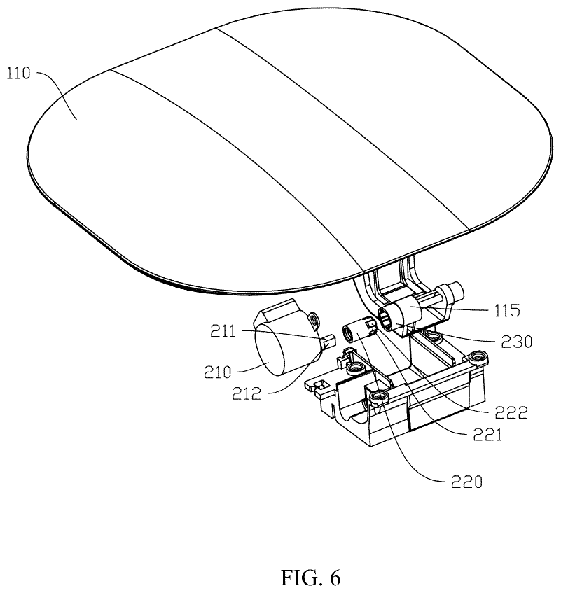

It can be understood that, referring to FIGS. 3 and 6, the sliding member 220 is provided with an insertion hole 224, an inner wall of the insertion hole 224 protrudes to form a positioning portion 223, and the output shaft 211 is provided with a flat surface 212, and the flat surface 212 abuts against the positioning portion 223. By arranging the flat surface 212 on the outside of the output shaft 211, when the output shaft 211 is inserted into the insertion hole 224, the flat surface 212 abuts against the positioning portion 223, so that when the output shaft 211 rotates, the sliding member 220 is driven to rotate, thereby driving the transmission member 230 to rotate. In addition, the flat surface 212 can fit with the positioning portion 223, reducing the gap between the output shaft 211 and the insertion hole 224, and improving the connecting stability between the output shaft 211 and the sliding member 220.

A trash can according to an embodiment in the second aspect of the present disclosure includes a mounting ring 120, a lip 110 and the sliding device according to the embodiment in the first aspect of the present disclosure. The lip 110 is hinged with the mounting ring 120, and the transmission member 230 drives the lip 110 to rotate. The elastic force of the connecting portions 221 drives the convex portions 222 to clamp with the respective recesses 231, so that the output shaft 211 of the motor 210 can cooperate with the transmission member 230 by the sliding member 220 to drive the lip 110 to rotate. When the lip 110 is subjected to an external force, the external force transmitted to the output shaft 211 exceeds the set value to make the connecting portions 221 deform, the output shaft 211 rotates, so that the convex portions 222 slide out of the respective recesses 231 and slide along the sliding surfaces 233 to realize the slippage between the output shaft 211 and the transmission member 230 until the external force transmitted to the output shaft 211 is lower than the set value, at which point the convex portions 222 and the recesses 231 are clamped again, thereby protecting the motor 210 from overload or damage caused by external forces and extending the lifespan of the motor 210.

It can be understood that, referring to FIG. 2, in the first implementation, the lip 110 is provided with a transmission shaft 111, one end of the transmission shaft 111 is provided with a first tooth portion 112, and the transmission member 230 is provided with a second tooth portion 232. As the first tooth portion 112 and the second tooth portion 232 are engaged with each other, the output shaft 211 drives the transmission shaft 111 to rotate, to open and close the lip 110. It can also be understood that the second tooth portion 232 is in a fan shape as a whole, and a rotating stroke of the transmission shaft 111 can be controlled by controlling the arc length of the second tooth portion 232, thus implementing the control for the rotating stroke of the lip 110.

It can be understood that, referring to FIG. 2, the mounting ring 120 is provided with a mounting seat 121, the transmission shaft 111 is hinged with the mounting seat 121, and the other end of the transmission shaft 111 is provided with a limiting block 113, and the limiting block 113 can abut against the mounting seat 121. Further, by arranging the limiting block 113 at the other end of the transmission shaft 111, when the transmission shaft 111 rotates until the limiting block 113 abuts against the mounting seat 121, the limiting block 113 prevents the transmission shaft 111 from rotating continuously, thus implementing the control for the rotating stroke of the lip 110.

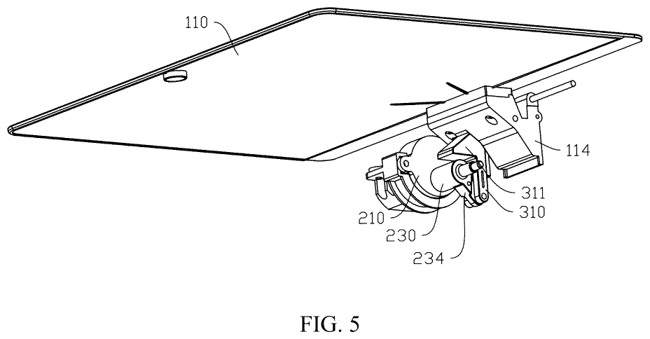

It can be understood that, referring to FIG. 5, in the second implementation, the transmission member 230 is provided with a first connecting rod 234, the lip 110 is provided with a first connecting block 114, the first connecting block 114 is hinged with the mounting ring 120, a second connecting rod 310 is disposed between the first connecting rod 234 and the first connecting block 114, one end of the second connecting rod 310 is hinged with the first connecting rod 234, and the other end of the second connecting rod 310 is hinged with the first connecting block 114. Through cooperation of the first connecting rod 234 with the second connecting rod 310, when the output shaft 211 drives the transmission member 230 to rotate, the first connecting rod 234 rotates and drives the second connecting rod 310 to rotate at the same time, to drive the connecting block to rotate, so that the lip 110 is opened and closed. Moreover, by changing the lengths of the first connecting rod 234 and the second connecting rod 310, the rotating stroke of the lip 110 can be adjusted, which is convenient and quick.

It can be understood that, referring to FIG. 5, the second connecting rod 310 protrudes to form a limiting portion 311, and the limiting portion 311 can abut against the transmission member 230 or the first connecting block 114. When the second connecting rod 310 rotates to a certain angle through the limiting portion 311 formed in a protruding manner, the limiting portion 311 abuts against the transmission member 230 or the first connecting block 114 to stop the second connecting rod 310 from rotating, thereby limiting the rotating stroke of the second connecting rod 310, and achieving the effect of setting the rotation range of the lip 110.

It can be understood that, referring to FIG. 6, in the third implementation, the lip 110 is provided with a second connecting block 115, the second connecting block 115 is hinged with the mounting ring 120, and the second connecting block 115 is connected to the transmission member 230. The transmission member 230 is directly connected to the second connecting block 115, so that the transmission member 230 directly drives the lip 110 to rotate, thereby realizing rapid opening and closing of the lip 110 and improving efficiency. It can also be understood that the second connecting block 115 and the transmission member 230 are integrally formed, which improves the connecting strength between the second connecting block 115 and the transmission member 230, thereby improving the rotating stability of the lip 110.

The embodiments of the present disclosure are described in detail above with reference to the accompanying drawings. However, the present disclosure is not limited to the above-mentioned embodiments. Within the scope of knowledge possessed by those of ordinary skill in the art, various changes may also be made without departing from the purpose of the present disclosure.

1. A sliding device, comprising:
a motor, provided with an output shaft;
a sliding member, disposed on the output shaft, wherein the sliding member forms a plurality of connecting portions protruding in an axial direction of the output shaft, the plurality of connecting portions are arranged at intervals in a circumferential direction of the output shaft, and each of the connecting portions is formed with a convex portion protruding in a radial direction of the output shaft; and
a transmission member, arranged around the sliding member, wherein the transmission member is provided with a plurality of recesses, each of the recesses matches with the respective convex portion, a sliding surface is disposed between each adjacent pair of the recesses, and each of the recesses is lamped with the respective convex portion to fix the transmission member and the sliding member, and the transmission member and the sliding member are rotatable relative to each other.

2. The sliding device according to claim 1, wherein the convex portion is provided with an arc surface matching with an inner wall of the respective recess.

3. The sliding device according to claim 1, wherein the sliding member is provided with an insertion hole, an inner wall of the insertion hole protrudes to form a positioning portion, the output shaft is provided with a flat surface, and the flat surface abuts against the positioning portion.

4. A trash can, comprising: a mounting ring, a lip, and the sliding device according to claim 1, wherein the lip is hinged on the mounting ring, and the transmission member is configured to drive the lip to rotate.

5. The trash can according to claim 4, wherein the lip is provided with a transmission shaft, one end of the transmission shaft is provided with a first tooth portion, the transmission member is provided with a second tooth portion, and the first tooth portion and the second tooth portion are engaged with each other.

6. The trash can according to claim 5, wherein the mounting ring is provided with a mounting seat, the transmission shaft is hinged with the mounting seat, the other end of the transmission shaft is provided with a limiting block, and the limiting block is capable of being abutting against the mounting seat.

7. The trash can according to claim 4, wherein the transmission member is provided with a first connecting rod, the lip is provided with a first connecting block, the first connecting block is hinged with the mounting ring, a second connecting rod is disposed between the first connecting rod and the first connecting rod, one end of the second connecting rod is hinged with the first connecting rod, and the other end of the second connecting rod is hinged with the first connecting block.

8. The trash can according to claim 7, wherein the second connecting rod protrudes to form a limiting portion, and the limiting portion is capable of being abutting against the transmission member or the first connecting block.

9. The trash can according to claim 4, wherein the lip is provided with a second connecting block, the second connecting block is hinged with the mounting ring, and the second connecting block is connected to the transmission member.

10. The trash can according to claim 9, wherein the second connecting block and the transmission member are integrally formed.
